(19) United States
(12) Patent Application Publication
(10) Pub. No.: US 2005/0010315 A1
(43) Pub. Date: Jan. 13, 2005

(54) Entirely solid state audio device

(76) Inventor: Martin S. Silverman, Camarillo, CA (US)

Correspondence Address: Bruce A. Jagger, P.O. Box 29000, Glendale, CA, 91209-9000, US

(21) Appl. No.: 10/879,827

(22) Filed: Jun. 29, 2004

Related U.S. Application Data
(60) Provisional application No. 60/484,143, filed on Jun. 30, 2003.

(51) Int. Cl. G06F 17/00

(52) U.S. Cl. 700/94; 381/334

(57) ABSTRACT

An entirely solid state audio device wherein a solid state audio player is preferably waterproofingly and shock dampingly enclosed within a case member. The audio player comprises a plurality of solid state components and does not include any electromechanical components. The operation of the audio device is controlled by a solid state control member that is operable from outside of the case. The control member is preferably a solid state optoelectronic control member. The optoelectronic control member is controllingly associated with the audio player. The optoelectronic control member does not include any electromechanical components. A typical optoelectronic control member includes a source or emitter of perturbatable radiation, such as light, and a radiation perturbation detector. The light or other radiation is controllingly perturbatable by an operator from outside of the case member. The perturbation is accomplished, for example, by providing a gap between the emitter and the detector, which gap is outside of the case in a pocket that is sized to controllingly receive the tip of an operator's finger. The control member can also be actuated by audible commands.

This Application claims the benefit of U.S. Provisional Application Ser. No. 60/484,143, filed Jun. 30, 2003.

### BACKGROUND OF THE INVENTION

1. Field of the Invention.

The invention relates in general to methods and devices pertaining to audio devices, and, more particularly, embodiments of the present invention relate to fully solid state audio players.

2. Description of the Prior Art.

Many audio devices had been previously proposed. Typically, such audio devices comprise electronic components that store or receive data, convert that data into an audibly perceivable form, and provide for the transmission of the data in that audibly perceivable form to a listener. Solid state components for these purposes are commonplace. Electromechanical control members and a power source are also typically found in conventional audio devices. One class of previously proposed audio devices includes portable audio devices in watertight cases. Such prior sealed audio devices were carried or worn by a person while under water. See, for example, Silverman U.S. Pat. No. 4,683,587, Polany U.S. Pat. No. 6,396,769, and May U.S. Pat. No. 5,889,730. Where an audio device is waterproofingly sealed, the presence of an electromechanical switch will typically contribute the majority of the system failures because the switch seals will leak. The problems with sealing electromechanical switches are apparent, for example, from a review of the expedients required to accomplish sealing such a switch as illustrated by Nishikawa et al. U.S. Pat. No. 5,258,592.

Control switches of many types and varieties had been previously proposed. One class of previously known switches includes optoelectronic switches. See, for example, Redmer et. al. U.S. Pat. No. 6,157,026, Beeck U.S. Pat. No. Re. 30,094, and Hollow U.S. Pat. No. 4,584,510. Typically, such optoelectronic switches employ moveable shutters shutteringly interposed between a light source and a light sensor. Physical movement of the shutter under the control of an operator either breaks or makes a beam of light from the light source, which is sensed by the light sensor. These prior art devices and methods are not without their shortcomings. The physical movement of the shutter is necessary to the operation of such devices. This adds weight, complexity, expense, and a potential failure point to the system. Also, the requirement for the installation of the components of a mechanical element in a system adds cost and complexity to the manufacturing procedure.

These and other difficulties of the prior art have been overcome according to the present invention.

### BRIEF SUMMARY OF THE INVENTION

The present invention has been developed in response to the current state of the art, and in particular, in response to these and other problems and needs that have not been fully or completely solved by currently available audio devices. Thus, it is an overall object of the present invention to effectively resolve at least the problems and shortcomings identified herein. In particular, it is an object of the present invention to provide a completely solid state audio player, including the controls therefore, which has no electromechanical components. It is also an object of the present invention to provide a solid state audio player that is controlled by the perturbation of electromagnetic radiation without the use of electromechanical components. Finally, it is an object of the present invention to provide a solid state audio player which is waterproof and is controlled by an electromechanical free optoelectronic switch. Embodiments of the present invention are particularly suitable for use in water sports and other underwater applications.

To acquaint persons skilled in the pertinent arts most closely related to the present invention, a preferred embodiment of an audio device that illustrates a best mode now contemplated for putting the invention into practice is described herein by, and with reference to, the annexed drawings that form a part of the specification. The exemplary audio device assembly is described in detail without attempting to show all of the various forms and modifications in which the invention might be embodied. As such, the embodiments shown and described herein are illustrative, and as will become apparent to those skilled in the arts, can be modified in numerous ways within the scope and spirit of the invention, the invention being measured by the appended claims and not by the details of the specification or drawings.

The present invention thus has among its various desirable features the provision of an audio device that includes a waterproofingly sealed audio player. The audio player is constructed of a plurality of solid state components, and is completely free of electromechanical components. A suitable power supply, typically, a secondary battery is provided to power the audio player. Suitable headphones such as those described, for example, in Silverman U.S. Pat. No. 4,683,587 (in the ear) or May U.S. Pat. No. 5,889,730 (through the mastoid bone) are employed with the audio device. Connection to the headphones is typically through a waterproof jack although wireless connections can be used, if desired. Control of the audio device is accomplished by the use of a solid state switch member that depends for the communication of signals on the controlled perturbation of electromagnetic radiation at perturbation sites associated with the audio device. One suitable form of such a solid state switch is, for example, an optoelectronic switch where the light from a light source is perturbatable from outside the case by the insertion of an operators finger tip between the light source and a light sensor. Preferably, the solid state components of the audio player are shock mounted. The shock mounting can also serve as a waterproofing encapsulant for the components, if desired. Encapsulating the components in a waterproof material, whether for the additional purposes of shock and vibration protection or not, avoids the necessity of providing seals for the case, thus decreasing the cost of manufacture and assembly.

In operation, an audio device according to the present invention is controlled by perturbation of the electromagnetic radiation. A plurality of perturbation sites can be provided if desired so that various operations are performed by various combinations of perturbation at the various sites and within one perturbation site. Preferably, the audio device provides some control information to the operator. For example, an audible signal describing or indicating the available options may be generated and transmitted to the operator responsive to the perturbation of the electromagnetic radiation at one or more perturbation sites. One particular pattern of perturbation may be required to change the volume while another is required to change the selection of data. In general, the sequenced perturbation of the electromagnetic radiation at perturbation sites is used to control the audio device.

Other objects, advantages, and novel features of the present invention will become more fully apparent from the following detailed description of the invention when considered in conjunction with the accompanying drawings, or may be learned by the practice of the invention as set forth herein.

### BRIEF DESCRIPTION OF THE DRAWINGS

The present invention provides its benefits across a broad spectrum of audio devices. While the description which follows hereinafter is meant to be representative of a number of such applications, it is not exhaustive. As those skilled in the art will recognize, the basic apparatus taught herein can be readily adapted to many uses. This specification and the claims appended hereto should be accorded a breadth in keeping with the scope and spirit of the invention being disclosed despite what might appear to be limiting language imposed by the requirements of referring to the specific examples disclosed.

Referring particularly to the drawings for the purposes of illustrating the invention and its presently understood best mode only and not limitation:

FIG. 1 is a front elevational view of a preferred embodiment of an audio device of the invention wherein the source of power is outside of the interior cavity of the case.

FIG. 2 is a top plan view of the embodiment of FIG. 1.

FIG. 3 is an end view of the embodiment of FIG. 1.

FIG. 4 is an end view of the embodiment of FIG. 1 partially in cross-section along line 4-4 in FIG. 2 showing the electromagnetic radiation perturbation site in cross-section.

FIG. 5 is an exploded front elevational view of the embodiment of FIG. 1 showing the battery separated from the case.

FIG. 6 is a front elevational view of the embodiment of FIG. 1 partially in cross-section along line 6-6 in FIG. 2 showing the electromagnetic radiation perturbation site in cross-section.

FIG. 7 is a diagrammatic cross-sectional view of a further preferred embodiment wherein the power source and the power replenishment member are located within the case, and the case is formed from a pliant closed cell foam that is skinned on the outside and fills the interior with a waterproofing and shock absorbing encapsulant.

### DETAILED DESCRIPTION OF THE PREFERRED EMBODIMENTS

Referring now to the drawings wherein like reference numerals designate identical or corresponding parts throughout the several views. It is to be understood that the drawings are diagrammatic and schematic representations of various embodiments of the invention, and are not to be construed as limiting the invention in any way. The use of words and phrases herein with reference to specific embodiments is not intended to limit the meanings of such words and phrases to those specific embodiments. Words and phrases herein are intended to have their ordinary meanings, unless a specific definition is set forth at length herein.

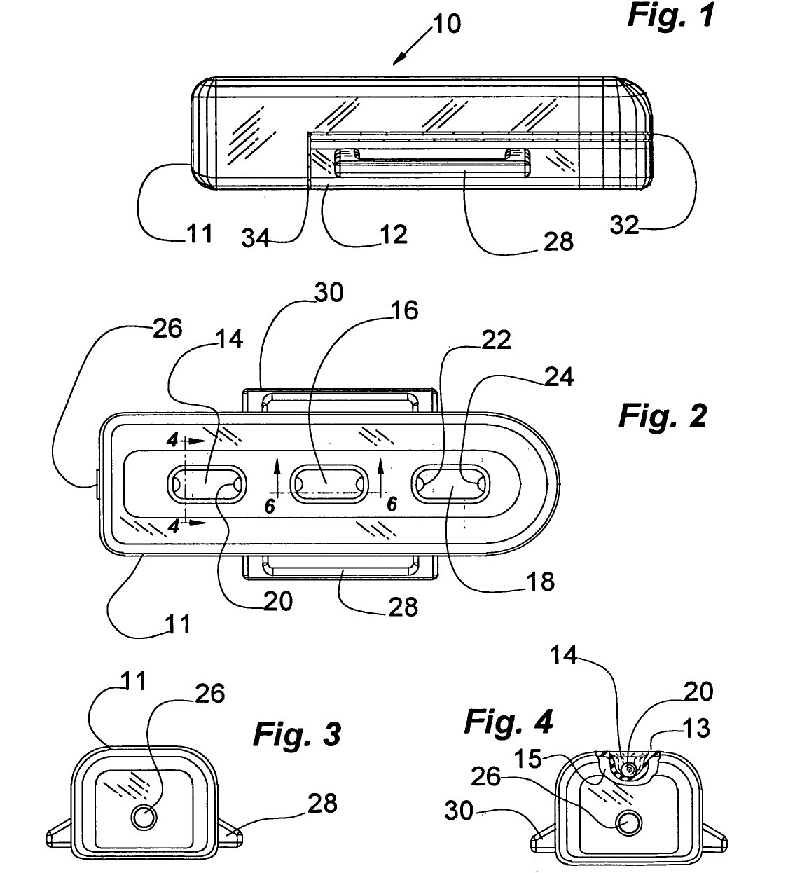

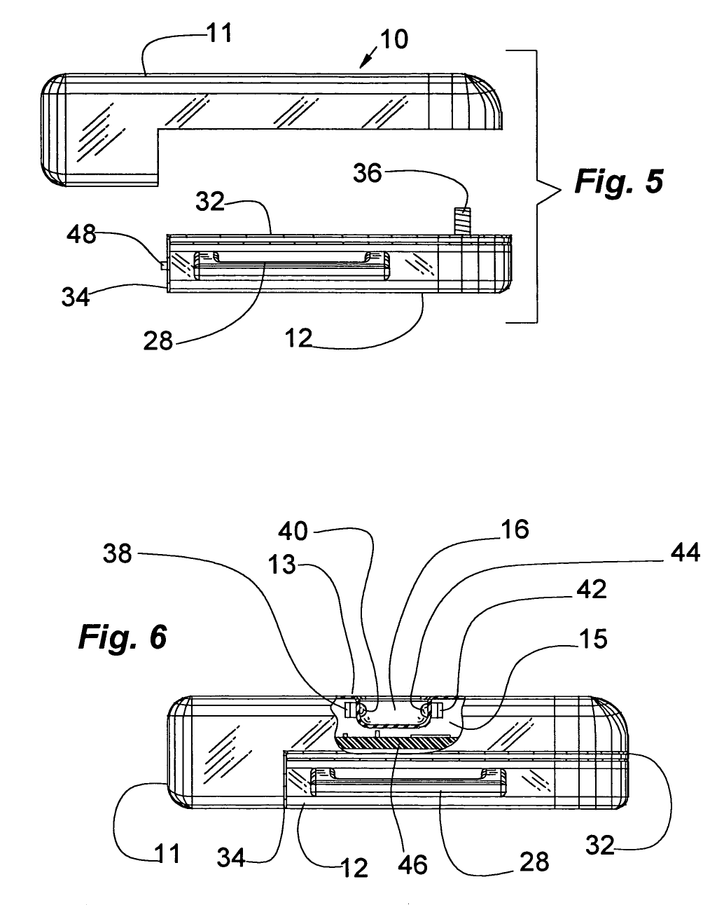

Referring particularly to the drawings, there is illustrated generally at 10 an audio device comprising an audio player waterproofingly confined within a case element 11, and a power source 12. Power source 12 is in its own case, which is separable from case element 11. Water tight seals 32 and 34 seal the joint between the two cases. Power source 12 is mounted to case element 11 by means of screw 36 (FIG. 5). Case element 11 comprises a wall 13 (FIGS. 4 and 6) that encloses an interior region 15. In the preferred embodiment of FIGS. 1 through 6, wall 13 is waterproofingly sealed, and the assembly of solid state components that comprise the audio player, including, for example, printed circuit board 46, are waterproofingly enclosed within interior region 15. Wall 13 is penetrated only by electrical connector 48, which conductively couples power source 12 to the audio player, and by headphone jack port 26. Port 26 is conductively connected to the other components of the audio player, and, preferably, is not connected to interior region 15 by way of any physical openings. Port 26, when mated with a suitable conventional waterproof jack member, not shown, is capable of transmitting data to an operator's headphones, not shown. Preferably, port 26 is bidirectional so it is also capable of receiving data and conducting it to the other components, such as flash memory devices, and the like, within the interior 15. Further, charging of the battery or other power source can also be accomplished through this port.

The audio device 10 is controlled by perturbating electromagnetic radiation, for example, light, in the gaps between emitting and detecting elements within pockets 14, 16, and 18. A perturbation detecting element is illustrated, for example, at 42 in FIG. 6. An emitter of perturbatable electromagnetic radiation is illustrated, for example, at 38 in FIG. 6. In the embodiment selected for the purposes of illustration, the emitter-detector pair, 38-42, is composed of solid state devices free of any electromechanical components. This emitter-detector pair is located entirely within the interior region of case element 11. This emitter detector pair is waterproofingly sealed within the case element 11. At least a part of the electromagnetic radiation emitted by the solid state emitter 38 passes through window 40 into the gap within pocket 16 between emitter 38 and detector 42. In this embodiment the gap in pocket 16 is adapted to receive the fingertip of an operator for the purpose of communicating control signals to the audio device. The detector 42 receives information concerning the electromagnetic radiation through window 44. Windows 40 and 44 are mounted in case element 11 in water tight engagement. Windows 40 and 44 are preferably at least partially transparent to the electromagnetic radiation. The emitter-detector pair, 38, 42 together comprise a solid state switch or control member.

Strap receiving loops 28 and 30 provide convenient attachment points for mounting audio device 10 to a person. A strap, not shown, when passed through loops 28 and 30 can, for example, be wrapped around an operator's arm and secured there.

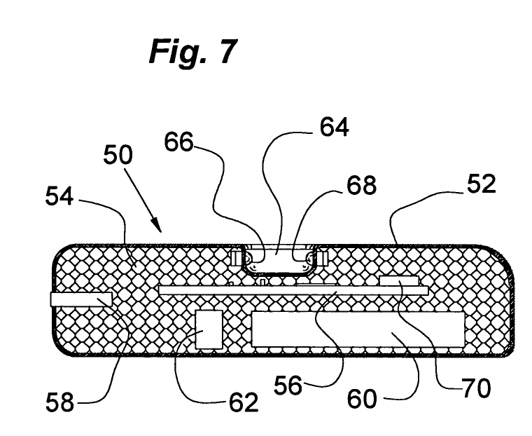

With particular reference to the preferred embodiment illustrated in FIG. 7, an audio device indicated generally at 50 is comprised of a body of generally closed cell foam in interior region 54 enclosed within a case element 52. Case element 52 is preferably waterproof and composed of the same material as the generally closed cell foam. Case element 52 is conveniently formed as a skin on the body of foam during a molding process. The skin does not foam so it is fully water impervious. Other materials can be used to form the case element, if desired. Such materials need not be chemically related to the foam material. Encapsulated within the body of foam are power source 60, power replenishment member 62, printed circuit board 56, headphone jack port 58, and the components that form a solid state switch. Printed circuit board 56 is populated with various solid state components of the audio player, including, for example, a central processor chip 70. The components of the solid state switch include pocket 64 and windows 66 and 68. An electromagnetic radiation emitter-detector pair is associated with windows 66 and 68 as previously described with reference to the preferred embodiment of FIGS. 1-6. The body of generally closed cell foam in the interior region 54 of audio device 50 serves at least two functions. Along with case element 52 it protects the solid state components of the audio player from water. It also serves as a shock damper for the assembly of components. Where power source 60 is a secondary battery, it requires recharging from time to time. Power replenishment member 62 is adapted to receive energy inductively and apply it to the recharging of power source 60. Since there are no electromechanical components associated with the audio device 50, the solid state components can be completely encapsulated without providing for any physical manipulation of the components through the case element.

The operation of the audio device is accomplished by the perturbation of electromagnetic radiation. The electromagnetic radiation is perturbatable by an operator without physically entering the interior region of the case element either directly or by some indirect mechanical linkage. The radiation emitter-detector pair is preferably an optoelectronic switch. The emitter and detector can be incorporated into the same unit if desired. Reflected radiation, for example, can be detected with an integrated emitter-detector component. Radiation is in the form of light (wavelengths including the visible and somewhat beyond from approximately near UV to near infrared), is preferred for many applications by reason of safety, cost, and convenience. Many light emitting sources are readily available. Perturbatable radiation can be generated using, for example, tritium or other soft nuclear emissions such as beta particles that are transformed into light by the use of a scinttillant, or a phosphorescent material that is charged by electromagnetic energy, electrochemical energy, or sonic energy. Perturbatable radiation can also be generated by one or more light emitting diodes, or the like. Where the audio device is intended to be used only in strong ambient light, such as sunshine, the light source can be ambient light. The perturbation of radiation in the form of light can be detected by optoelectronic switch members, photovoltaic cells, photoresistive elements such as cadmium sulfide cells, phototransistors, photodiodes, and, in general, any device that can detect a perturbation in light. Detectable perturbation generally takes place in a gap between the emitter and the perturbation detector. For example, breaking, reflecting, or diverting the radiation generates a detectable perturbation in the radiation. Those skilled in the art will appreciate that other switches or control members operating with other frequencies of radiation, including, for example, visible, near visible, radio frequency, and the like frequencies, can be employed if desired. The radiation can be emitted in a beam or more generally distributed, as may be desired for a particular application. So long as they are waterproofingly and controllingly associated with the audio device the radiation emitter-detector elements can be located wholly within, partially within, or outside of the case element.

The components that are required to construct an audio player are well known and readily available, so no detailed description of them will be provided here. Typically, an assembly of solid state components is mounted on a printed circuit board, although, as will be recognized by those in the art, other mounting arrangements can be used, if desired. Most, if not all, of the components can be incorporated into a single chip, if desired.

The provision of full functionality requires the presence of solid state memory that does not depend on electromechanical components, for example, flash memory, or the like. Data is typically stored in non-volatile digital form on solid state memory. Data can be transferred into and out of the solid state memory through a port, or wirelessley, if desired. Suitable ports include, for example, the jack port for the headphones, a separate port, or the like. Data exchange can also be effected through the solid state control members. For example, a radiation detector can be programmed to accept data input.

A central processor unit is required for the successful operation of the audio device. A considerable amount of input and output of data, control signals, and power is necessary. The control member is switchingly associated with the rest of the audio device. Preferably, a command tree is associated with the control member so that one controlling action by an operator triggers the option of taking several other actions. For example, if the audio device is turned on by the insertion of a headphone jack in the appropriate port, the operator may be informed through a recorded message transmitted to the headphones that placing a fingertip in a particular control pocket will initiate the playing of a command menu. The command menu may, for example, offer the options of finding a particular prerecorded piece of music by quickly inserting a fingertip into a particular control pocket, or playing a particular recording by rapidly inserting and withdrawing a fingertip three times into a particular control pocket. Similar control actions involving sequential perturbation of electromagnetic radiation in a gap or gaps between one or more emitter-detector pairs can be provided for all of the desired functions of the audio device from recording or erasing data, adjusting volume and other sound variables, to determining the charge level and recharging the power source, and the like. As will appreciated by those in the art, command information can be entered by or communicated to an operator in other detectable forms, including, for example, visible, audible and tactile forms, and by other devices, if desired. The capabilities of a central processor unit are required to accomplish these functions, particularly those of generating and communicating a command menu, and fashioning the appropriate response to an operator's input. In general, a read only memory member is also associated with the central processor unit. The provision of central processor units, their capabilities, and the implementation of those capabilities are well known to those skilled in the art.

Where piezoelectric transducer units are present in the headphones that are attached to the audio device, operator commands can, if desired, be generated by the operator speaking commands that are picked up by the transducers and transmitted back to the audio device through the jack port. As will be appreciated by those skilled in the art, other forms of transducers can also be similarly back driven.

The nature and location of the power source that is poweringly associated with the audio player is not critical so long as it provides a reliable supply of the required power. One or more primary or secondary electrochemical cells can be used if desired. Fuel cells and certain capacitors, and even nuclear batteries can be used, if desired. Where secondary electrochemical cells are used, the task of waterproofing the system is simplified by permanently sealing the cells into the audio device and recharging them inductively. Where a number of cells are present the central processor unit is preferably programmed to control the load and charging functions so that the proper power is provided to each of the components in the assembly of solid state components on an as needed basis, and the individual cells are not over or under charged. Other power sources and arrangements for powering the audio device will occur to those in the art.

The description of the components of the audio device as being “solid state” is intended to include all functional components that are free of electromechanical components. Thus, devices that depend on the flow of electrons “solid state electronic devices”, devices that depend on the flow of photons, “solid state photon devices”, or devices that depend on biological processes “solid state bio-devices”, and combinations thereof, are intended to be included. Typically, microcontrollers and solid-state processors in general require some device for the regulation of clock speed, and the like. The available clock speed regulators include crystal oscillators. Crystal oscillators are sometimes described as electromechanical clocking devices. For purposes of the present invention, crystal oscillators and the like are not considered to be electromechanical components. As used herein and in the appended claims the phrase “no electromechanical components” does not exclude crystal oscillators.

As will be appreciated by those skilled in the art, many modifications and variations of the present invention are possible in light of the above teachings. It is therefore to be understood that, within the scope of the appended claims, the invention may be practiced otherwise than as specifically described. What have been described are preferred embodiments in which modifications and changes may be made without departing from the spirit and scope of the accompanying claims. Obviously, many modifications and variations of the present invention are possible in light of the above teachings. It is therefore to be understood that, within the scope of the appended claims, the invention may be practiced otherwise than as specifically described.

1. An audio device comprising:
a case element including an interior region;
a solid state audio player waterproofingly mounted within said interior region, said solid state audio player being comprised of an assembly of solid state components and including no electromechanical components, said assembly including at least a data output member, a data storage member, and a processor member, said audio device including an electromechanical component free optoelectronic switch member, said optoelectronic switch member being switchingly associated with the other said members and being operable from outside of said interior region; and
a power source poweringly associated with said solid state audio player.

2. An audio device of claim 1 wherein said optoelectronic switch member comprises a light perturbation detecting element positioned to detect perturbation of light, and said solid state audio device being controllable by sequenced perturbation of said light.

3. An audio device of claim 1 wherein said optoelectronic switch member comprises a light emitting element positioned to project a perturbatable light into a gap, and a perturbation detecting element detectingly associated with said gap, said gap being perturbatingly accessible from outside of said interior region, said audio device being controllable by perturbation of said light in said gap, said solid state audio player being adapted to generating a menu of command information relating to perturbatably controlling said audio device, and said menu being detectable by an operator of said audio device.

4. An audio device of claim 3 wherein said perturbation detecting element is adapted to detecting when said light is at least partially reflected.

5. An audio device of claim 3 wherein said perturbation detecting element is adapted to detecting when said light is at least partially blocked.

6. An audio device of claim 3 wherein said light emitting element comprises tritium and a scinttilllant.

7. An audio device of claim 3 wherein said light emitting element comprises a light emitting diode.

8. An audio device of claim 1 wherein said power source is a secondary battery positioned within said internal region, and said solid state audio device includes a power source replenishment member positioned within said interior region.

9. An audio device of claim 8 wherein said power source replenishment member is not conductively connected through said case element to a source of power.

10. An audio device of claim 8 wherein said power source replenishment member is conductively connected through said case element to a source of power.

11. An audio device of claim 8 wherein said power source replenishment member is adapted to being inductively connected through said case element to a source of power.

12. An audio device of claim 1 wherein said power source is a secondary battery, said secondary battery is positioned outside of said interior region, and said secondary battery is conductively connected to said solid state audio player.

13. An audio device of claim 1 wherein said power source is a secondary battery, said secondary battery is positioned outside of said interior region, and said secondary battery is inductively connected to said solid state audio player.

14. An audio device of claim 1 wherein said power source replenishment member is outside of said interior region.

15. An audio device of claim 1 including a plurality of said optoelectronic switch members.

16. An audio device comprising:
a case element having an interior region; and
a solid state audio player waterproofingly confined within said interior region, said solid state audio player being comprised of an assembly of solid state components, said assembly being free of electromechanical components and including at least an data output member, a solid state data storage member, and a processor member, said audio device including a solid state switch member, said switch member being switchingly associated with the other said members, said switch member including a source of perturbatable electromagnetic radiation and an electromagnetic radiation perturbation detector, said electromagnetic radiation being perturbatable from outside of said interior region.

17. An audio device of claim 16 wherein said source of electromagnetic radiation is positioned within said interior region.

18. An audio device of claim 16 wherein said source of electromagnetic radiation comprises a source of radio frequency radiation.

19. An audio device of claim 16 wherein said source of electromagnetic radiation comprises a source of visible radiation.

20. An audio device of claim 16 wherein said source of electromagnetic radiation is adapted to projecting a beam of electromagnetic radiation.

21. An audio device comprising:
a case member having an interior region;
an audio player waterproofingly confined within said interior region, said audio player comprising a plurality of solid state components and being free of electromechanical components; and
a solid state optoelectronic control for said audio device, said optoelectronic control being operatively accessible by an operator without entering said interior region, said optoelectronic control being controllingly connected to said audio player.

22. An audio device of claim 21 wherein said case member is waterproofingly sealed.

23. An audio device of claim 21 wherein said audio player is waterproofingly encapsulated within said case member.

24. An audio device of claim 21 including a mechanical shock damping member shock dampingly associated with said audio player.

25. An audio device of claim 21 wherein said solid state optoelectronic control is at least partially positioned within said interior region.

26. An audio device of claim 21 wherein said solid state optoelectronic control is at least partially positioned within said case member.

27. An audio device of claim 21 wherein said solid state optoelectronic control is at least partially positioned outside of said interior region.

28. An audio device comprising:
a case member having an interior region;
an audio player confined within said interior space, said audio player comprising a plurality of solid state components and being free of electromechanical components; and
said audio device including a solid state control member controllingly associated with said audio player, said control member including a source of perturbatable electromagnetic radiation and an electromagnetic radiation perturbation detector, said electromagnetic radiation being perturbatable at a location outside of said interior region.

29. An audio device of claim 28 wherein said audio player includes a menu generating member adapted to generating a menu of command information relating to perturbatably controlling said audio device, and said menu being detectable by said operator.

30. An audio device of claim 29 wherein said menu generating member is adapted to generating a menu that is least partly audibly detectable.

31. An audio device of claim 29 wherein said menu generating member is adapted to generating a menu that is at least partly visibly detectable.

32. An audio device of claim 28 including a mechanical shock damping member shock dampingly associated with said audio player.

33. An audio device comprising:
a case member having an interior space;
an audio player waterproofingly confined within said interior space, said audio player comprising a plurality of solid state components and being free of electromechanical components;
said audio device including a solid state optoelectronic control member controllingly associated with said audio player, said optoelectronic control member being free of electromechanical members and including a source of perturbatable light and a light perturbation detector, said light being perturbatable by an operator from outside of said interior space;
a mechanical shock damping member within said interior space and shock dampingly associated with said audio player; and p1 a secondary battery poweringly associated with said audio device.

34. An audio device comprising:
a case member comprising closed cell foamed material;
an audio player waterproofingly and shock dampingly encapsulated within said case member, said audio player comprising a plurality of solid state components and being free of electromechanical components;
said audio device including a solid state optoelectronic control member controllingly associated with said audio player, said optoelectronic control member being free of electromechanical members and including a source of perturbatable light and a light perturbation detector, said light being perturbatable by an operator from outside of said case member.

35. An audio device comprising:
a case element including an interior region;
a solid state audio player mounted within said interior region, said solid state audio player being comprised of an assembly of solid state components, said assembly including no electromechanical components, said assembly including at least a data output member, a data storage member, a processor member, and a control member, said control member being controllingly associated with the other said members and operable from outside of said interior region; and
a power source poweringly associated with said solid state audio player.

36. An audio device of claim 35 wherein said power source is located in said interior region and said power source includes no electromechanical components.

37. An audio device of claim 35 wherein all communications with said data output and storage members from outside of said interior are adapted to being accomplished wirelessley

38. An audio device of claim 35 wherein said power source is rechargeable and is located in said interior region, said power source being rechargeable from outside of said interior without a wire connection.

39. An audio device of claim 35 wherein said control member is adapted to being actuated at least in part by audible commands.

40. An audio device of claim 35 wherein said solid state audio player is waterproofingly confined within said interior region.

41. An audio device comprising:
a case element including an interior region;
a solid state audio player mounted within said interior region, said solid state audio player being comprised of an assembly of solid state components, said assembly including no electromechanical components, said assembly including at least a data output member, a data storage member, a processor member, a power source poweringly associated with said solid state audio player, and a control member, said control member being controllingly associated with the other said members and operable from outside of said interior region, and communications with said data output and storage members being adapted to being accomplished wirelessley.
